(19) United States
(12) Patent Application Publication
(10) Pub. No.: US 2024/0210207 A1
(43) Pub. Date: Jun. 27, 2024

(54) METHOD AND DEVICE FOR DETERMINING AND PROVIDING ENVIRONMENTAL FEATURE INFORMATION AND FOR CREATING A MAP

(71) Applicant: Robert Bosch GmbH, Stuttgart (DE)

(72) Inventors: Andre Wagner, Hannover (DE); Erik Einhorn, Sarstedt (DE); Julian Lindner, Hannover (DE); Matthias Roland, Hildesheim (DE); Maurice Seer, Elze (DE); Nicolas Fischer, Hannover (DE); Pierre Lothe, Hildesheim (DE); Tobias Ritter, Hildesheim (DE)

(21) Appl. No.: 18/531,904

(22) Filed: Dec. 7, 2023

(30) Foreign Application Priority Data
Dec. 23, 2022 (DE) 102022214400.7

(51) Int. Cl. G01C 21/00

(52) U.S. Cl. CPC G01C 21/3841; G01C 21/3807

(57) ABSTRACT

A method and a device for determining and providing environmental feature information. A method and a device for creating a map are also described.

### CROSS REFERENCE

The present application claims the benefit under 35 U.S.C. § 119 of German Patent Application No. DE 10 2022 214 400.7 filed on Dec. 23, 2022, which is expressly incorporated herein by reference in its entirety.

### FIELD

The present invention relates, inter alia, to a method for determining and providing environmental feature information, starting from first and second environmental data values and dependent on first and second movement behaviors, and to a method for creating a map, depending on the previously determined and received environmental feature information.

### SUMMARY

According to an example embodiment of the present invention, a method for determining and providing environmental feature information comprises a step of sensing first environmental data values representing a first environment of a first vehicle, a step of sensing a first movement behavior of the first vehicle, and a step of receiving second environmental data values representing a second environment of a second vehicle, wherein the first environment and the second environment at least partially have a common region, wherein the common region comprises at least one environmental feature. The method furthermore comprises a step of receiving a second movement behavior of the second vehicle, a step of determining the environmental feature information, starting from the first and second environmental data values, depending on the first and second movement behaviors, wherein the environmental feature information comprises a position and a description of the at least one environmental feature, and a step of providing the environmental feature information.

A vehicle is, for example, understood to mean a manually operated vehicle (SAE level 0) or an automated vehicle in accordance with one of SAE levels 1 to 5 (see SAE J3016 standard).

According to an example embodiment of the present invention, the first and second environmental data values are sensed by means of an environmental sensor system designed for this purpose. An environmental sensor system is understood to mean at least one video sensor and/or at least one radar sensor and/or at least one lidar sensor and/or at least one ultrasonic sensor and/or at least one further sensor that is designed to sense an environment of a vehicle in the form of environmental data values. In one possible embodiment, the environmental sensor system comprises, for example, a computing unit (processor, working memory, hard drive) with suitable software and/or is connected to such a computing unit for this purpose.

According to an example embodiment of the present invention, the second environmental data values are sensed by the second vehicle and subsequently transmitted to the first vehicle. These data values are transmitted by means of a wireless car-2-car connection suitable for this purpose.

In this case, the second environmental data values comprise the environmental feature and at least one distance between the second vehicle and the environmental feature, wherein this distance is correspondingly sensed or determined by the second vehicle and transmitted to the first vehicle. An environmental feature is, for example, understood here to mean an infrastructure feature (roadway boundary lines, guardrails, etc.) and/or a traffic sign (road signs, traffic lights, etc.) and/or a structural feature (buildings, bridges, tunnels, etc.) and/or a further feature that can be sensed by means of an environmental sensor system. In one embodiment, the extrinsic and intrinsic sensor calibration parameters are additionally transmitted.

A movement behavior is, for example, understood to mean a current velocity and/or a velocity profile and/or a current acceleration and/or an acceleration behavior and/or further information.

Environmental features are, for example, understood here to mean infrastructure features (roadway boundary lines, guardrails, etc.) and/or traffic signs (road signs, traffic lights, etc.) and/or structural features (buildings, bridges, tunnels, etc.) and/or further features that can be sensed by means of an environmental sensor system.

A description of the at least one environmental feature is, for example, understood to mean the classification of the corresponding environmental feature into the aforementioned categories (infrastructure features, traffic signs, structural features, etc.). In this case, further classification categories are also possible, for example depending on the design of the environmental sensor system (video, radar, lidar, etc.).

A position of the environmental feature is, for example, understood to mean a 3D specification in a specified coordinate system, e.g., WGS84 coordinates.

Providing the environmental feature information is, for example, understood to mean transmitting this information in the form of data values to an external server (here: the second device for creating a map, for example).

The method according to the present invention may advantageously achieve an object of providing a method for determining and providing environmental feature information. This object is achieved by means of the method according to an example embodiment of the present invention in that simultaneous measurements of locally adjacent vehicles are carried out in the vehicles (here: the first vehicle) themselves and are used for cooperative aggregation of the environmental features (landmarks). In this case, use is made of the fact that adjacent vehicles, which are, for example, traveling on parallel lanes of a multi-lane road, observe the same landmarks from laterally greatly different positions. The resulting base distances of the observations are, for example, over 3.5 m for typical lane widths. As a result, accurate depth determination and position estimation are also possible for distant landmarks. In addition to the significantly improved accuracy of the position estimation, the cooperative aggregation offers the further advantage that the amount of data during the transmission to the mapping server (here: the second device) can be further reduced in that each vehicle no longer transmits all observations, but only one vehicle of a group reports the results of the aggregation to the server. This does not lead to any loss of information, since all observations of the adjacent vehicles have already been taken into account in the determination of the positions of the landmarks.

Preferably, according to an example embodiment of the present invention, starting from the first movement behavior and starting from the second movement behavior, a relative distance between the first vehicle and the second vehicle is determined, wherein the first and the second environmental data values are combined (aggregated) depending on the relative distance, in order to determine the environmental feature information. Each individual determination of the position (per vehicle) regularly generates errors, in particular in the depth direction. However, as a result of the vehicles' own movements and their relative distance to one another, each sensed environmental feature is advantageously observed from slightly different positions. If these observations of adjacent vehicles are merged in one of the vehicles (here: the first vehicle), the movement parallax resulting therefrom can be used to reconstruct the actual position relative to the vehicle.

According to an example embodiment of the present invention, further environmental data values and further movement behaviors are preferably received by at least one further vehicle, wherein the further environmental data values represent at least one further environment of the at least one further vehicle, wherein the at least one further environment comprises the common region, wherein the determination of the environmental feature information, starting from the first, second and further environmental data values, takes place depending on the first, second and further movement behaviors.

Preferably, according to an example embodiment of the present invention, each of the first and/or the second and/or the further movement behavior comprises a pose of the corresponding vehicle, and the determination of the environmental feature information takes place additionally depending on the respective pose.

A pose is generally understood to mean a position and an orientation of an object in relation to a specified coordinate system.

Preferably, according to an example embodiment of the present invention, the environmental feature information is determined by means of bundle block adjustment and/or by means of SLAM methods.

According to an example embodiment of the present invention, the first device, in particular a control unit, is configured to perform all steps of the method for determining and providing environmental feature information according to the present invention.

According to an example embodiment of the present invention, the device or computing unit comprises a processor, working memory, storage medium, and suitable software in order to perform the method according to one of the methods of the present invention disclosed herein. Furthermore, the device comprises an interface in order to transmit and receive data values by means of a wired and/or wireless connection, for example with corresponding devices of vehicles (control units, communication devices, environmental sensor system, navigation system, etc.) and/or further off-board devices (server, cloud, etc.).

Furthermore, according to an example embodiment of the present invention, a computer program is provided comprising instructions which, when the computer program is executed by a computer, cause the computer to perform a method according to one of the methods of the present invention disclosed herein for determining and providing environmental feature information. In one example embodiment of the present invention, the computer program corresponds to the software comprised by the second device.

Furthermore, a machine-readable storage medium on which the computer program is stored is program.

According to an example embodiment of the present invention, the method for creating a map comprises a step of receiving environmental feature information, which is determined according to one of the methods according to the present invention for determining and providing environmental feature information, a step of creating the map, depending on the received environmental feature information, and a step of providing the map.

Creating the map depending on the received environmental feature information is, for example, understood to mean that environmental features comprised by the environmental feature information are newly integrated according to their position into a base map and/or environmental features already comprised by the base map are correspondingly removed or adapted. A base map is understood here in particular to mean a digital map.

A digital map is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein environmental features comprised by the radar map are stored along with a radar signature. A further map layer comprises, for example, a lidar map, wherein environmental features comprised by the lidar map are stored along with a lidar signature.

In one embodiment of the present invention, the map is designed as a highly accurate map. The highly accurate map is in particular designed in such a way that it is suitable for the navigation of an automated vehicle. This is understood, for example, to mean that the highly accurate map is designed to determine a highly accurate position of the automated vehicle by comparing stored environmental features with sensed sensor data values of this automated vehicle. For this purpose, the highly accurate map, for example, comprises these environmental features along with highly accurate position specifications (coordinates).

A highly accurate position is understood to mean a position which is accurate within a specified coordinate system, e.g., WGS84 coordinates, in such a way that this position does not exceed a maximum permitted uncertainty. The maximum uncertainty may depend on the environment, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

According to an example embodiment of the present inventio, the second device, in particular a computing unit, is configured to perform all steps of the method for creating a map according to the present invention.

The device or computing unit comprises a processor, working memory, storage medium, and suitable software in order to perform the method for creating the map. Furthermore, the device comprises an interface in order to transmit and receive data values by means of a wired and/or wireless connection, for example with corresponding devices of vehicles (control units, communication devices, environmental sensor system, navigation system, etc.) and/or further devices (server, cloud, etc.).

In one embodiment of the present invention, the computing unit is, for example, understood to mean a server or a server network or a cloud. In this case, the environmental feature information transmitted by a vehicle (here: the first vehicle) is received by this server or by this cloud. Furthermore, the map can be transmitted in the form of data values to further (automated) vehicles, for example in order to determine a position.

Advantageous developments of the present invention are disclosed herein.

### BRIEF DESCRIPTION OF THE DRAWINGS

Exemplary embodiments of the present invention are illustrated in the figures and explained in more detail in the following description.

FIG. 1 shows an exemplary embodiment of the method according to the present invention for determining and providing environmental feature information in the form of a flow chart.

FIG. 2 shows an exemplary embodiment of the method according to the present invention for creating a map in the form of a flow chart.

### DETAILED DESCRIPTION OF EXAMPLE EMBODIMENTS

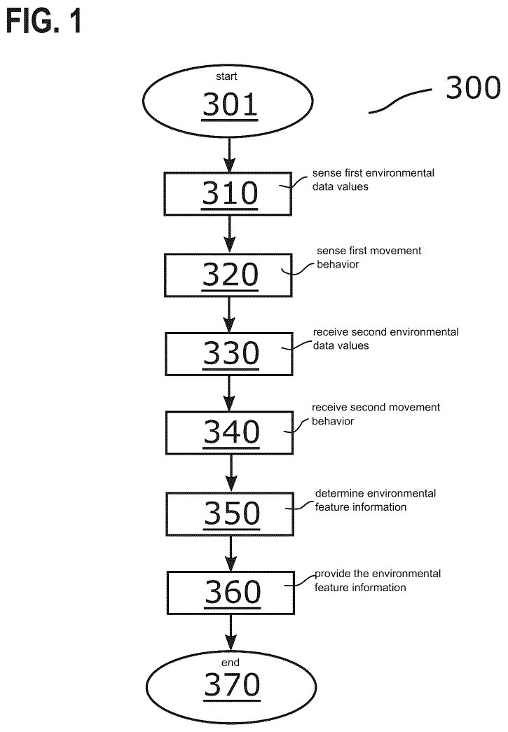

FIG. 1 shows an exemplary embodiment of a method 300 for determining 350 and providing 360 environmental feature information.

In step 301, the method 300 starts.

In step 310, first environmental data values representing a first environment of a first vehicle are sensed.

In step 320, a first movement behavior of the first vehicle is sensed.

In step 330, second environmental data values representing a second environment of a second vehicle are received. In this case, the first environment and the second environment at least partially have a common region, wherein the common region comprises at least one environmental feature.

In step 340, a second movement behavior of the second vehicle is received.

In step 350, the environmental feature information, starting from the first and second environmental data values, is determined depending on the first and second movement behaviors, wherein the environmental feature information comprises a position and a description of the at least one environmental feature.

In step 360, the environmental feature information is provided.

In step 370, the method 300 ends.

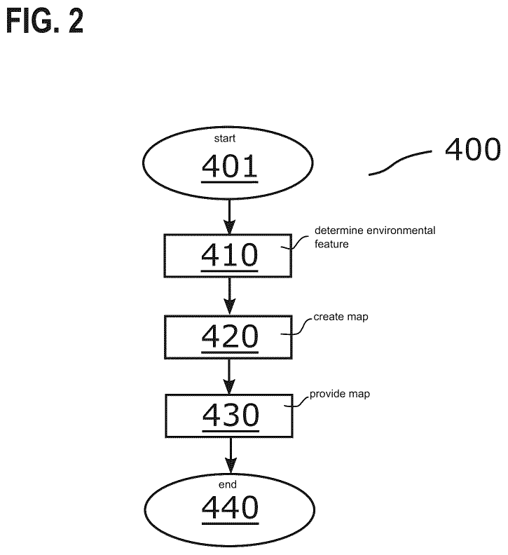

FIG. 2 shows an exemplary embodiment of a method 400 for creating 420 a map.

In step 401, the method 400 starts.

In step 410, environmental feature information determined according to FIG. 1 is received.

In step 420, the map is created depending on the received environmental feature information.

In step 430, the map is provided.

In step 440, the method 400 ends.

What is claimed is:

1. A method for determining and providing environmental feature information, the method comprising the following steps:
sensing first environmental data values representing a first environment of a first vehicle;
sensing a first movement behavior of the first vehicle;
receiving second environmental data values representing a second environment of a second vehicle, wherein the first environment and the second environment at least partially have a common region, wherein the common region includes at least one environmental feature;
receiving a second movement behavior of the second vehicle;
determining the environmental feature information, starting from the first and second environmental data values, depending on the first and second movement behaviors, wherein the environmental feature information includes a position and a description of the at least one environmental feature; and
providing the environmental feature information.

2. The method according to claim 1, wherein, starting from the first movement behavior and starting from the second movement behavior, a relative distance between the first vehicle and the second vehicle is determined, the first and the second environmental data values being combined depending on the relative distance, in order to determine the environmental feature information.

3. The method according to claim 1, wherein further environmental data values and further movement behaviors are received by at least one further vehicle, the further environmental data values representing at least one further environment of the at least one further vehicle, the at least one further environment including the common region, the determination of the environmental feature information taking place, starting from the first, second and further environmental data values, depending on the first, second and further movement behaviors.

4. The method according to claim 1, wherein the first and/or the second and/or the further movement behavior includes a pose of the first and/or the second and/or further vehicle, and the determination of the environmental feature information takes place additionally depending on the pose.

5. The method according to claim 1, wherein the environmental feature information is determined using bundle block adjustment and/or using SLAM methods.

6. A first device, comprising:
a control unit configured to determining and providing environmental feature information, the control unit configured to:
sense first environmental data values representing a first environment of a first vehicle;
sense a first movement behavior of the first vehicle;
receive second environmental data values representing a second environment of a second vehicle, wherein the first environment and the second environment at least partially have a common region, wherein the common region includes at least one environmental feature;
receive a second movement behavior of the second vehicle;
determine the environmental feature information, starting from the first and second environmental data values, depending on the first and second movement behaviors, wherein the environmental feature information includes a position and a description of the at least one environmental feature; and
provide the environmental feature information.

7. A non-transitory machine-readable storage medium on which is stored a computer program for determining and providing environmental feature information, the computer program, when executed by a computer, causing the computer to perform the following steps:
sensing first environmental data values representing a first environment of a first vehicle;
sensing a first movement behavior of the first vehicle;
receiving second environmental data values representing a second environment of a second vehicle, wherein the first environment and the second environment at least partially have a common region, wherein the common region includes at least one environmental feature;
receiving a second movement behavior of the second vehicle;
determining the environmental feature information, starting from the first and second environmental data values, depending on the first and second movement behaviors, wherein the environmental feature information includes a position and a description of the at least one environmental feature; and
providing the environmental feature information.

8. A method for creating a map, the method comprising the following steps:
receiving environmental feature information determined by:
sensing first environmental data values representing a first environment of a first vehicle,
sensing a first movement behavior of the first vehicle,
receiving second environmental data values representing a second environment of a second vehicle, wherein the first environment and the second environment at least partially have a common region, wherein the common region includes at least one environmental feature,
receiving a second movement behavior of the second vehicle, and
determining the environmental feature information, starting from the first and second environmental data values, depending on the first and second movement behaviors, wherein the environmental feature information includes a position and a description of the at least one environmental feature;
creating the map depending on the received environmental feature information; and
providing the map.

9. A second device, comprising:
a computing unit configured to creating a map, the method comprising the following steps:
receive environmental feature information determined by:
sensing first environmental data values representing a first environment of a first vehicle,
sensing a first movement behavior of the first vehicle,
receiving second environmental data values representing a second environment of a second vehicle, wherein the first environment and the second environment at least partially have a common region, wherein the common region includes at least one environmental feature,
receiving a second movement behavior of the second vehicle, and
determining the environmental feature information, starting from the first and second environmental data values, depending on the first and second movement behaviors, wherein the environmental feature information includes a position and a description of the at least one environmental feature;
create the map depending on the received environmental feature information; and
provide the map.
